(19) United States
(12) Patent Application Publication
(10) Pub. No.: US 2026/0250984 A1
(43) Pub. Date: Aug. 27, 2026

(54) ANTI-KNOCK LOCK

(71) Applicant: XIAMEN MAKE SECURITY TECHNOLOGY CO., LTD., Xiamen, Fujian (CN)

(72) Inventors: Fuyun LIN, Xiamen (CN); Guanghui Luan, Xiamen (CN)

(21) Appl. No.: 18/727,664

(22) PCT Filed: Jan. 11, 2022
(86) PCT No.: PCT/CN2022/071295

§ 371 Date: Jul. 9, 2024

(51) Int. Cl. E05B 47/06; E05B 47/00

(52) U.S. Cl. CPC E05B 47/0607; E05B 47/0012; E05B 2047/0024

(57) ABSTRACT

Disclosed is an anti-knock lock, comprising a lock case, and a bolt, a stop block, a power device, a cam, a sliding rod, a first reset piece and a second reset piece which are arranged in the lock case. The lock case is provided with a lock hole. The middle of the bolt is rotationally connected to the lock case, one end of the bolt being in a telescopic fit at the lock hole. The middle of the stop block is rotationally connected to the lock case. The power device is in a driving connection to the cam and is used for driving the cam to rotate. The cam is arranged opposite to the sliding rod, the sliding rod moving along with rotation of the cam. The sliding rod is in a sliding fit with the lock case and points to the lock hole. The stop block rotates along with movement of the sliding rod so as to block or allow the rotation of the bolt. The first reset piece is used for providing an elastic force so as to enable the bolt to be reset to a locked state, in which one end of the bolt extends out of the lock hole. The second reset piece is used for providing an elastic force so as to enable the sliding rod to be reset to a locked state, in which the sliding rod drives the stop block to block the rotation of the bolt. The present invention, while having a knock-unlocking-prevention function, realizes a simplified structure and reduces cost.

### PRIORITY CLAIM

In accordance with 37 C.F.R. 1.76, a claim of priority is included in an Application Data Sheet filed concurrently herewith. Accordingly, the present invention claims priority to PCT Patent Application No. PCT/CN2022/071295, entitled “ANTI-KNOCK LOCK”, filed Jan. 11, 2022. The contents of the above referenced application are incorporated herein by reference in their entirety.

### TECHNICAL FIELD

The present invention relates to the technical field of locks, and in particular to an anti-knock lock.

### BACKGROUND

Currently, a safe box has gradually become a commonly used security product, and the safety performance of the safe box is closely related to the function of locksets. In recent years, with the continuous improvement of related technologies, the demand for upgrading safe lock products has been increased, and product safety performance has been gradually improved. There are several types of safe lock structures on the market as follows: \textcircled{1} a motor drives an eccentric wheel to rotate so that it avoids the bolt to achieve unlocking; and \textcircled{2} a motor drives a latch through a spring to avoid a bolt latch, so that when a bolt is rotated, the bolt latch can retreat to achieve unlocking.

Among the aforementioned two solutions, the eccentric wheel of the former solution is reset by a torsion spring, and thus during the unlocking, it is necessary to continuously supply power to the motor to stall the motor. When the unlocking time is relatively long, the stall current of the motor will be relatively high. This solution consumes a lot of power, which seriously reduces the service life of a battery. The latch of the latter solution is relatively thin and not strong enough, and the latch is driven by a spring, so there is a risk of knocking to open the lock, and thus an anti-knock unlocking mechanism needs to be added into the lock, which leads to a complex structure of the lockset with high cost, many parts, and low reliability and stability of the lock.

### SUMMARY

### Technical Problem

An objective of the present invention is to provide an anti-knock lock, which achieves the purpose of simplifying the structure and reducing the cost, while having an anti-knock unlocking function.

### Solution for the Problem

### Technical Solution

In order to achieve the aforementioned objective, a solution of the present invention is: an anti-knock lock, which includes a lock case, and a bolt, a stop block, a power device, a cam, a sliding rod, a first reset piece, and a second reset piece that are arranged in the lock case. The lock case is provided with a lock hole. The middle of the bolt is rotatably connected to the lock case, one end of the bolt being in a telescopic fit at the lock hole. The middle of the stop block is rotatably connected to the lock case. The power device is in a driving connection to the cam and is used for driving the cam to rotate. The cam is arranged opposite to the sliding rod, and the sliding rod moves along with the rotation of the cam. The sliding rod is in a sliding fit with the lock case and points to the lock hole. The stop block rotates along with the movement of the sliding rod to block or allow the rotation of the bolt. The first reset piece is used for providing an elastic force to enable the bolt to be reset to a locked state, in which one end of the bolt extends out of the lock hole. The second reset piece is used for providing an elastic force to enable the sliding rod to be reset to a locked state, in which the sliding rod drives the stop block to block the rotation of the bolt.

When the lock is knocked by an external force, the bolt and the stop block will rotate, and the bolt will contact the stop block before the stop block reaches an unlocking position.

The bolt is an eccentric structure, and when subjected to the same external force, the bolt has a rotational inertia greater than that of the stop block, so that the rotation angle of the bolt is greater than that of the stop block. When the bolt contacts the stop block, the stop block is in a position that blocks the rotation of the bolt towards an unlocking direction.

The other end of the bolt is provided with a first plane. One end of the stop block is provided with a second plane. When the lock is in the locked state, the first plane is arranged opposite to the second plane. When the lock is knocked by an external force to enable the bolt to contact the stop block, an edge of the second plane abuts the first plane.

A center of mass of the stop block is located at its rotation axis.

One end of the stop block is provided with a movable pin, and one end of the sliding rod is radially provided with a movable groove for sliding fit with the movable pin.

The lock case is further provided with a boss for limiting the rotation angle of the stop block.

The power device is a motor, and the cam is coaxially connected onto a motor shaft of the motor.

The sliding rod is provided with a baffle for fitting the cam, and the cam and the second reset piece are respectively fitted on two sides of the baffle.

When the lock is in an unlocked state, the contact point between the cam and the baffle is lower than a shaft center height of the cam.

The first reset piece is a spring, one end of which is connected to an inner wall of the lock case and the other end of which is connected to the other end of the bolt. The other end of the bolt is provided with a latch to be connected with the first reset piece. The second reset piece is a spring, one end of which is sleeved on the other end of the sliding rod and the other end of which abuts the inner wall of the lock case.

### BENEFICIAL EFFECTS OF THE PRESENT INVENTION

### Beneficial Effects

After the aforementioned technical solution is adopted, the structure of the lock of the present invention is simple and reliable. Adopting a combination of the bolt and the stop block not only ensures the basic locking and unlocking functions of the lock, but also realizes anti-knock unlocking through the linkage relationship of the cam, the sliding rod, and the stop block. Compared with other locks, the same function can be achieved with fewer parts, which not only simplifies the structure and reduces the cost, but also increases the stability and reliability of the lock.

### BRIEF DESCRIPTION OF THE ACCOMPANYING DRAWINGS

### Description of the Accompanying Drawings

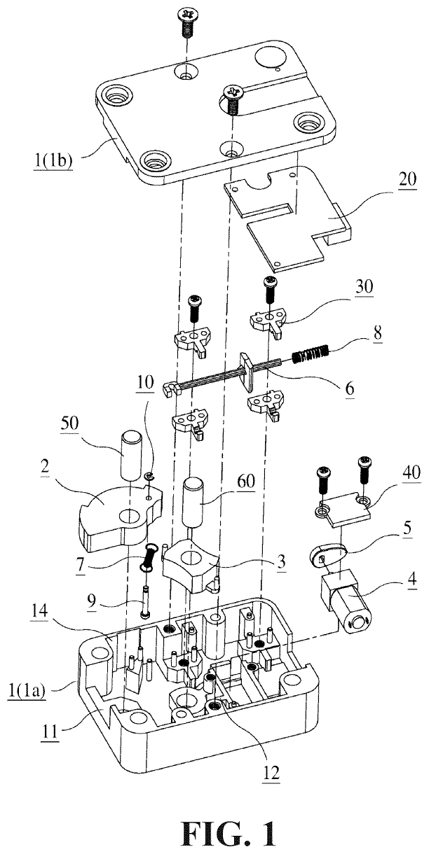

FIG. 1 is an exploded view of a specific embodiment of the present invention.

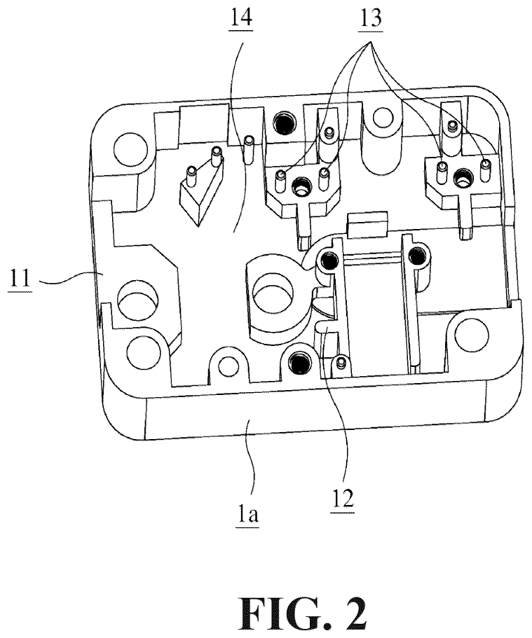

FIG. 2 is a perspective view of a case body according to a specific embodiment of the present invention.

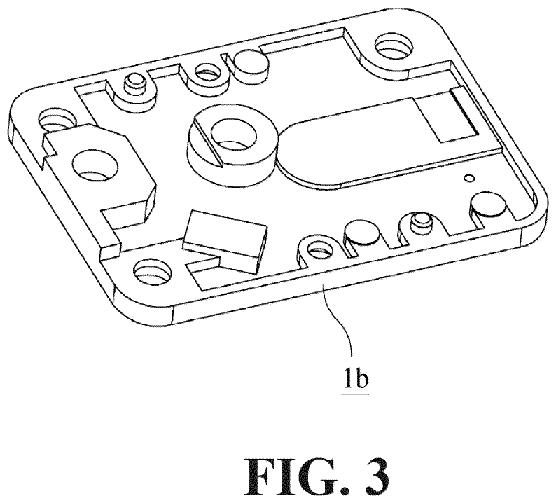

FIG. 3 is a perspective view of a cover body according to a specific embodiment of the present invention.

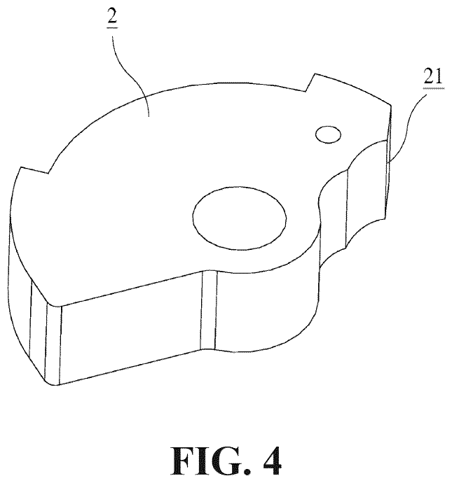

FIG. 4 is a perspective view of a bolt according to a specific embodiment of the present invention.

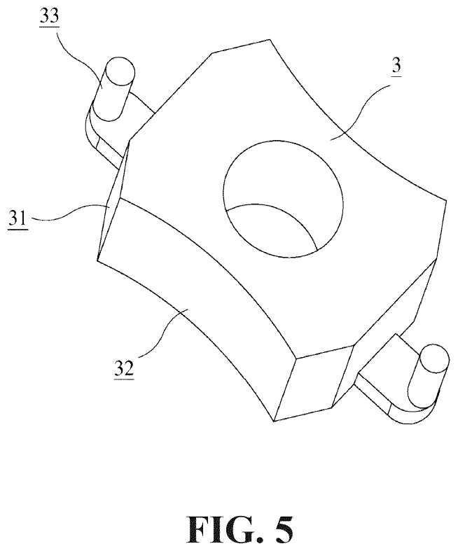

FIG. 5 is a perspective view of a stop block according to a specific embodiment of the present invention.

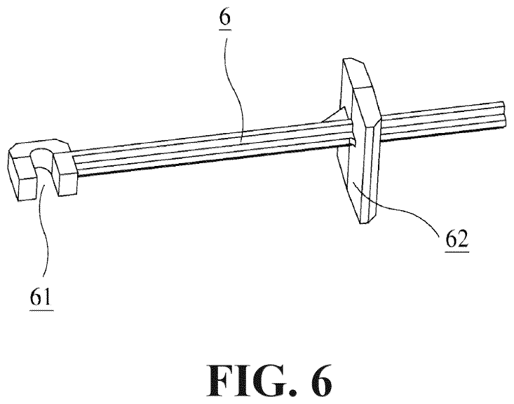

FIG. 6 is a perspective view of a sliding rod according to a specific embodiment of the present invention.

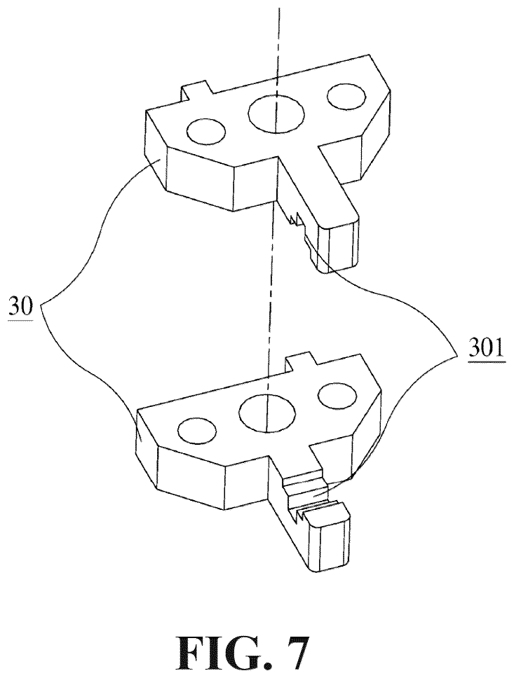

FIG. 7 is a perspective view of a sliding rod bracket according to a specific embodiment of the present invention.

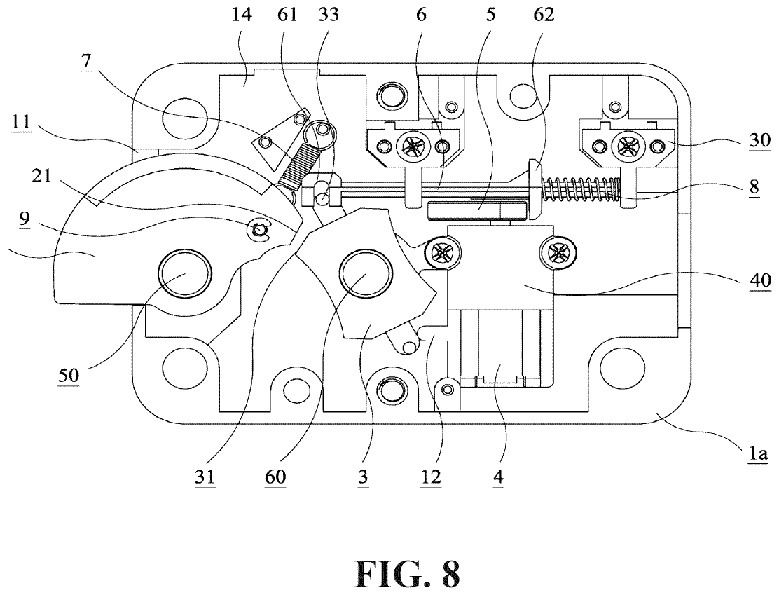

FIG. 8 is a schematic structural diagram of a locked state according to a specific embodiment of the present invention.

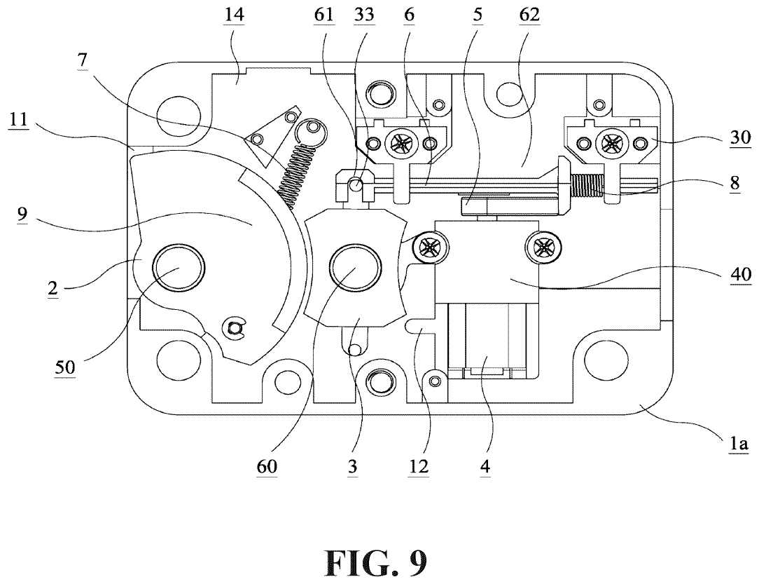

FIG. 9 is a schematic structural diagram of an unlocked state according to a specific embodiment of the present invention.

Description of reference numerals: 1—-lock case; 1a—case body; 1b—cover body; 11—lock hole; 12—boss; 13—positioning pin; 14—mounting cavity; 2—bolt; 21—first plane; 3—stop block; 31—second plane; 32—arc face; 33—movable pin; 4—power device; 5—cam; 6—sliding rod; 61—movable groove; 62—baffle; 7—first reset piece; 8—second reset piece; 9—pin; 10—snap spring; 20—circuit board; 30—sliding rod bracket; 301—special-shaped hole; 40—pressing plate; 50—first rotation axis; and 60—second rotation axis.

### DETAILED DESCRIPTION

### Implementations of the Present Invention

In order to further explain the technical solution of the present invention, the present invention will be described in detail below through specific examples.

The present invention is an anti-knock lock, which includes a lock case 1, and a bolt 2, a stop block 3, a power device 4, a cam 5, a sliding rod 6, a first reset piece 7, and a second reset piece 8 that are arranged in the lock case 1.

The lock case 1 is provided with a lock hole 11.

The middle of the bolt 2 is rotatably connected to the lock case 1, one end of the bolt being in a telescopic fit at the lock hole 11.

The middle of the stop block 3 is rotatably connected to the lock case 1.

The power device 4 is in a driving connection to the cam 5 and is used for driving the cam 5 to rotate.

The cam 5 is arranged opposite to the sliding rod 6, and the sliding rod 6 moves along with the rotation of the cam 5.

The sliding rod 6 is in a sliding fit with the lock case 1 and points to the lock hole 11. The stop block 3 rotates along with the movement of the sliding rod 6 to block or allow the rotation of the bolt 2.

The first reset piece 7 is used for providing an elastic force to reset the bolt 2 to a locked state, in which one end of the bolt 2 extends out of the lock hole 11.

The second reset piece 8 is used for providing an elastic force to reset the sliding rod 6 to a locked state, in which the sliding rod 6 drives the stop block 3 to block the rotation of the bolt 2.

Through the aforementioned solution, the structure of the lock of the present invention is simple and reliable. Adopting a combination of the bolt 2 and the stop block 3 not only ensures the basic locking and unlocking functions of the lock, but also realizes anti-knock unlocking through the linkage relationship of the cam 5, the sliding rod 6, and the stop block 3. Compared with other locks, the same function can be achieved with fewer parts, which not only simplifies the structure and reduces the cost, but also increases the stability and reliability of the lock.

Referring to FIGS. 1 to 7, specific embodiments of the present invention are shown (the following directional description is done with reference to the directions in FIGS. 8 and 9).

When the present utility model is knocked by an external force, the bolt 2 and the stop block 3 will rotate, and the bolt 2 will contact the stop block 3 before the stop block 3 reaches the unlocking position.

Furthermore, the aforementioned bolt 2 is an eccentric structure, and when subjected to the same external force, the rotational inertia of the bolt 2 is greater than that of the stop block 3, so that the rotation angle of the bolt 2 is greater than that of the stop block 3. When the bolt 2 contacts the stop block 3, the stop block 3 is in a position that blocks the rotation of the bolt 2 towards an unlocking direction. That is, when subjected to the same external force (in the same process of knocking by the external force), the rotation speed of the bolt 2 is greater than that of the stop block 3. Before the stop block 3 rotates to the position that allows the rotation of the bolt 2, the bolt 2 has already contacted the stop block 3 and is blocked from continuing to rotate by the stop block 3, thereby avoiding the occurrence of unlocking through knocking with the external force.

The other end of the aforementioned bolt 2 is provided with a first plane 21, and one end of the stop block 3 is provided with a second plane 31. When the lock is in the locked state, the first plane 21 is arranged opposite to the second plane 31. When the bolt is knocked by an external force or when it is attempted to push the bolt 2 to rotate clockwise, the first plane 21 will abut (the edge of) the second plane 31, so that the bolt 2 cannot rotate further, and one end of the bolt 2 cannot retract into the lock hole 11. That is, unlocking cannot be achieved.

A side of the aforementioned stop block 3 is provided with an arc face 32 for allowing the bolt 2 to rotate.

One end of the aforementioned stop block 3 is provided with a movable pin 33. One end of the sliding rod 6 is radially provided with a movable groove 61 for sliding fit with the movable pin 33. During the movement of the sliding rod 6, the movable pin 33 moves up and down in the movable groove 61 to realize the lateral movement of the sliding rod 6, which can drive the stop block 3 to rotate.

The aforementioned stop block 3 is designed so that its center of mass is set at an axis hole of the stop block 3. It is preferred that the center of the axis hole coincides with the center of mass. In this way, the center of mass of an actually produced part will be relatively close to the center of the second rotation axis 60, which minimizes the rotational inertia of the stop block 3 when it rotates around a rotation axis after knocking.

The aforementioned lock case 1 is also provided therein with a boss 12 for limiting the rotation angle of the stop block 3. Under the action of the second reset piece 8, the sliding rod 6 drives the stop block 3 to move, so that the other end of the stop block 3 abuts the boss 12, achieving the extreme position for blocking the stop block 3 when the stop block rotates counterclockwise.

The power device 4 is a motor, and then the cam 5 is coaxially connected to the motor shaft of the motor. In this embodiment, the power device 4 adopts a gear motor, so that the cam 5 can be driven with a relatively small power (generally less than one turn) to drive the sliding rod 6 to move into position, thereby achieving the purpose of power saving.

The sliding rod 6 is provided with a baffle 62 for fitting the cam 5, and the cam 5 and the second reset piece 8 are respectively fitted on two sides of the baffle 62.

Furthermore, in the unlocked state, the contact point between the cam 5 and the baffle 62 is designed to be lower than the shaft center height of the cam 5 (i.e., the aforementioned motor shaft). This ensures that after the power is cut off, the sliding rod 6 will not push the cam 5 to rotate reversely and then cause locking again under the action of the second reset piece 8, but rather the baffle 62 on the sliding rod 6 abuts the cam 5 under the action of the second reset piece 8 and causes the cam 5 to rotate towards and abut tightly the inner wall of the lock case 1. In this way, even if the power is cut off, the cam 5, the sliding rod 6, and the stop block 3 will not move under the action of the second reset piece 8. That is, the lock can still remain in the unlocked state even if the power is cut off, thereby achieving the purpose of power saving.

The aforementioned first reset piece 7 is a spring, one end of which is connected to the inner wall of the lock case 1 and the other end of which is connected to the other end of the bolt 2.

Further, the other end of the aforementioned bolt 2 is provided with a latch 9 for connecting the first reset piece 7. In this embodiment, the latch 9 is inserted into the other end of the bolt 2 and then fixed by a snap spring 10.

The aforementioned second reset piece 8 is a spring, one end of which is sleeved on the other end of the sliding rod 6 and the other end of which abuts the inner wall of the lock case 1.

The present invention further includes a circuit board 20 mounted in the lock case 1. The circuit board 20 is electrically connected to the power device 4 and is used for receiving an external control signal and controlling the working state of the power device 4.

The present invention further includes a sliding rod bracket 30 mounted in the lock case 1. The rod body portion of the sliding rod 6 (excluding the movable groove 61 and the baffle 62 at the end) is configured with a special-shaped cross-section. The sliding rod bracket 30 is provided with a special-shaped hole 301 matching the special-shaped cross-section. The function of providing the sliding rod bracket 30 is to stabilize the moving direction of the sliding rod 6, and through the matching of the special-shaped cross-section of the rod body with the special-shaped hole 301, the sliding rod 6 does not rotate when moving, thereby ensuring the functional stability of the sliding rod 6 and ensuring the transmission relationship between the sliding rod 6 and the stop block 3. In this embodiment, the sliding rod bracket 30 is divided into upper and lower pieces for sandwiching the upper and lower sides of the sliding rod 6 to facilitate assembly, and both ends of the sliding rod 6 is each provided with a sliding rod bracket 30.

Further, the section of the rod body of the aforementioned sliding rod 6 is cross-shaped.

Meanwhile, the lock case 1 is provided with several positioning pins 13 for positioning and fitting of the sliding rod bracket 30. The sliding rod bracket 30 is plug-fitted with the positioning pins 13 and is locked and fixed to the inner wall of the lock case 1 through screws to ensure the fixing of the position of the sliding rod bracket 30.

The present invention further includes a pressing plate 40 for fixing the power device 4 to ensure that the position of the power device 4 in the lock case 1 is stable, thereby ensuring that the driving function of the cam 5 for the sliding rod 6 is stable.

The present invention further includes a first rotation axis 50 and a second rotation axis 60. The first rotation axis 50 and the second rotation axis 60 are both mounted in the lock case 1; the middle of the lock case 1 is sleeved on the first rotation axis 50 to realize its rotational connection with the lock case 1; and the middle of the stop block 3 is sleeved on the second rotation axis 60 to realize its rotational connection with the lock case 1.

The aforementioned lock case 1 includes a case body la and a cover body 1b. The case body la is provided with an installation cavity 14, and the side wall of the mounting cavity 14 is provided with the aforementioned lock hole 11. The cover body 1b covers at the opening of the mounting cavity 14, so that the lock case 1 is in a closed state. In this embodiment, screws are employed for locking and fixing between the case body la and the cover body 1b to achieve detachable assembly. Moreover, various structures included in the aforementioned lock case 1 are also arranged in the mounting cavity 14.

The aforementioned cam 5 and sliding rod 6 are both made of low-density materials, such as plastics. The weight of the cam 5 and the sliding rod 6 is reduced as much as possible to reduce the acting force exerted by the cam 5 and the sliding rod 6 on the stop block when the lock is knocked by an external force, thereby avoiding unlocking via knocking.

Referring to FIG. 8, the locking process of the present invention is: in the unlocked state, the motor drives the cam 5 to rotate reversely, and the sliding rod 6 pushes the stop block 3 to rotate counterclockwise under the action of the second reset piece 8 (i.e., the spring). At this time, if the bolt 2 is still in the unlocked state, the stop block 3 will abut the bolt 2. After the external force for pushing the bolt 2 is removed, the bolt 2 will rotate counterclockwise to the locking position under the tension action of the first reset piece 7. After the bolt 2 leaves the stop block 3, the sliding rod 6 will continue to push the stop block 3 to rotate counterclockwise under the action of the second reset piece 8, until the stop block 3 abuts the boss 12. At this time, the first plane 21 of the bolt 2 is disposed opposite to the second plane 31 of the stop block 3. When it is attempted to push the bolt 2 to rotate clockwise, the first plane 21 will abut the second plane 31, so that the bolt 2 cannot rotate further, and one end of the bolt 2 cannot be retracted into the lock hole 11. That is, the lock cannot be unlocked.

Referring to FIG. 9, the unlocking process of the present invention is: in the locked state, the motor drives the cam 5 to rotate forward, and the cam 5 abuts the baffle 62 of the sliding rod 6 and causes the sliding rod 6 to move to the right against the elastic force of the second reset piece 8, and pushes the stop block 3 to rotate clockwise. The cam 5 no longer rotates after it abuts the inner wall of the lock case 1. At this time, the stop position of the stop block 3 can avoid the rotation trajectory of the bolt 2, and the unlocking is completed, so that the unlocking can be completed by pushing the bolt 2.

The working principle of the present invention is (including solutions for further improving various functions): (1) Principle of anti-knock unlocking: \textcircled{1} The stop block 3 is designed so that its center of mass is set at the axis hole of the stop block 3. It is preferred that the center of the axis hole coincides with the center of mass, so that the center of mass of an actually produced part will be relatively close to the center of the second rotation axis 60, which can minimize the rotational inertia of the stop block 3 when it rotates around the second rotation axis 60 after knocking, and the rotational inertia of the stop block 3 is smaller than that of the bolt 2.
\textcircled{2} The cam 5 and the sliding rod 6 are molded from low-density materials such as plastic, aluminum alloy, etc. to reduce the weight of the cam 5 and the sliding rod 6.

\textcircled{3} The bolt 2 is made of metal, and the bolt 2 is designed as an eccentric structure.
(2) Principle of anti-violent unlocking: When it is attempted to push the bolt 2 to unlock after locking, the first plane 21 of the bolt 2 abuts the second plane 31 of the stop block 3, and the force-bearing parts are: the bolt 2, the stop block 3, the first rotation axis 50, the second rotation axis 60, the case body la, and the cover body 1b. These parts are all made of metal and can be designed with sufficient thickness to ensure that the parts will not be damaged and can still be used normally after attempts of violent unlocking.
(3) Principle of power saving: During unlocking, the circuit board 20 supplies power to the motor, and the motor drives the cam 5 to rotate until the cam 5 pushes the sliding rod 6 to move back and then abut the inner wall of the lock case (i.e., the side wall of the case body 1a). At this time, the power can be cut off. Here, it is designed that the contact point between the cam 5 and the baffle 62 on the sliding rod 6 is lower than the center height of the motor shaft. This ensures that the sliding rod 6 will not push the cam 5 to rotate reversely and cause locking again after the power is cut off, but rather the baffle 62 on the sliding rod 6 will abut the cam 5 under the action of the elastic force exerted by the second reset piece 8, and the cam 5 in turn abuts the bottom wall of the case body la. In this way, even if the power is cut off, the cam 5, the sliding rod 6, and the stop block 3 will not move under the action of the elastic force exerted by the second reset piece 8. That is, when the power is cut off, the lock can be maintained in the unlocked state for a certain period of time, and then the circuit board 20 supplies power to the motor again, so that the motor to drive the cam 5 to rotate reversely, and the sliding rod 6 pushes the stop block 3 to rotate counterclockwise under the elastic force exerted by the second reset piece 8. After the bolt 2 returns to the locked position, the stop block 3 accordingly returns to the locked position. To sum up, the motor only needs to be powered during unlocking and locking, and since the motor rotates less than one turn at each time of unlocking and locking, it only takes a few tenths of a second to complete unlocking and locking, so there is no need to supply power to the motor during the period between unlocking and locking, which ensures that only a small amount of power is consumed each time of unlocking and locking.

The aforementioned embodiments and drawings do not limit the product forms and styles of the present invention. Any appropriate changes or modifications made by those of ordinary skills in the art shall be regarded as not departing from the patent scope of the present invention.

1. An anti-knock lock, comprising a lock case, and a bolt, a stop block, a power device, a cam, a sliding rod, a first reset piece, and a second reset piece that are arranged in the lock case, wherein the lock case is provided with a lock hole; the middle of the bolt is rotatably connected to the lock case, one end of the bolt being in a telescopic fit at the lock hole;
the middle of the stop block is rotatably connected to the lock case; the power device is in a driving connection to the cam and is used for driving the cam to rotate; the cam is arranged opposite to the sliding rod, and the sliding rod moves along with the rotation of the cam; the sliding rod is in a sliding fit with the lock case and points to the lock hole, and the stop block rotates along with the movement of the sliding rod to block or allow the rotation of the bolt; the first reset piece is used for providing an elastic force to enable the bolt to be reset to a locked state, in which one end of the bolt extends out of the lock hole; and the second reset piece is used for providing an elastic force to enable the sliding rod to be reset to a locked state, in which the sliding rod drives the stop block to block the rotation of the bolt.

2. The anti-knock lock according to claim 1, wherein: when the lock is knocked by an external force, the bolt and the stop block will rotate, and the bolt will contact the stop block before the stop block reaches an unlocking position.

3. The anti-knock lock according to claim 2, wherein: the bolt is an eccentric structure, and when subjected to the same external force, the bolt has a rotational inertia greater than that of the stop block, so that the rotation angle of the bolt is greater than that of the stop block, and when the bolt contacts the stop block, the stop block is in a position that blocks the rotation of the bolt towards an unlocking direction.

4. The anti-knock lock according to claim 2, wherein: the other end of the bolt is provided with a first plane; one end of the stop block is provided with a second plane; when the lock is in the locked state, the first plane is arranged opposite to the second plane; and when the lock is knocked by an external force to enable the bolt to contact the stop block, an edge of the second plane abuts the first plane.

5. The anti-knock lock according to claim 2, wherein: a center of mass of the stop block is located at its rotation axis.

6. The anti-knock lock according to claim 1, wherein: one end of the stop block is provided with a movable pin, and one end of the sliding rod is radially provided with a movable groove for sliding fit with the movable pin.

7. The anti-knock lock according to claim 1, wherein: the lock case is further provided with a boss for limiting the rotation angle of the stop block.

8. The anti-knock lock according to claim 1, wherein: the power device is a motor, and the cam is coaxially connected onto a motor shaft of the motor.

9. The anti-knock lock according to claim 1, wherein: the sliding rod is provided with a baffle for fitting the cam, and the cam and the second reset piece are respectively fitted on two sides of the baffle.

10. The anti-knock lock according to claim 9, wherein: when the lock is in an unlocked state, the contact point between the cam and the baffle is lower than a shaft center height of the cam.

11. The anti-knock lock according to claim 1, wherein: the first reset piece is a spring, one end of which is connected to an inner wall of the lock case and the other end of which is connected to the other end of the bolt; the other end of the bolt is provided with a latch to be connected with the first reset piece; and the second reset piece is a spring, one end of which is sleeved on the other end of the sliding rod and the other end of which abuts the inner wall of the lock case.
